(19) United States
(12) Patent Application Publication
(10) Pub. No.: US 2023/0222606 A1
(43) Pub. Date: Jul. 13, 2023

(54) METHOD AND SYSTEM

(71) Applicant: TOYOTA JIDOSHA KABUSHIKI KAISHA, Toyota-shi (JP)

(72) Inventor: Kentaro BAN, Susono-shi (JP)

(73) Assignee: TOYOTA JIDOSHA KABUSHIKI KAISHA, Toyota-shi (JP)

(21) Appl. No.: 18/151,148

(22) Filed: Jan. 6, 2023

(30) Foreign Application Priority Data
Jan. 11, 2022 (JP) 2022-002627

(51) Int. Cl. G06Q 50/06; G06Q 40/04; G06Q 10/02

(52) U.S. Cl. CPC G06Q 50/06; G06Q 10/02; G06Q 40/04; G06Q 20/14

(57) ABSTRACT

A method performed by a reservation apparatus for a charging facility installed in a control target area of electrical energy, the method includes: upon starting a trading period of a spot market for a target date of electrical energy trading, starting accepting a new usage reservation or a changed reservation for each time slot on the target date in a reservation table for the charging facility; upon starting a trading period of an hour-ahead market for the target date, performing first processing in which a usage fee for an available time slot in the reservation table is changed; and upon ending the trading period of the hour-ahead market for each frame on the target date, performing second processing in which a usage fee for an available time slot in the reservation table is changed or an acceptance of a reservation is prohibited.

### CROSS-REFERENCE TO RELATED APPLICATION

This application claims priority to Japanese Patent Application No. 2022-002627 filed on Jan. 11, 2022, the entire contents of which are incorporated herein by reference.

### TECHNICAL FIELD

The present disclosure relates to a method and a system.

### BACKGROUND

Technology for controlling electrical energy with taking into account supply and demand in the future is known. For example, Patent Literature (PTL) 1 discloses an electrical energy supply management system including: a charging apparatus configured to charge an electrical energy storage apparatus of a vehicle to which electrical energy is to be supplied; a data acquisition interface configured to record a time at which, required time during which, and electrical energy by which the vehicle has been charged, and a change in stored electrical energy; a demand prediction interface configured to predict, based on the recorded information, electrical energy required for charging and a time period during which charging should be performed; and an electrical energy supply controller configured to control the charging apparatus based on a prediction by the demand prediction interface.

### CITATION LIST

### Patent Literature

PTL 1: JP 2021-107951 A

### SUMMARY

There is room for improvement with respect to technology for controlling electrical energy with taking into account supply and demand in the future.

It would be helpful to improve technology for controlling electrical energy with taking into account supply and demand in the future.

A method according to an embodiment of the present disclosure is a method performed by a reservation apparatus for a charging facility installed in a control target area of electrical energy, the method includes:
upon starting a trading period of a spot market for a target date of electrical energy trading, starting accepting a new usage reservation or a changed reservation for each time slot on the target date in a reservation table for the charging facility;
subsequently, upon starting a trading period of an hour-ahead market for the target date, performing first processing in which a usage fee for an available time slot in the reservation table is changed based on the latest prediction on supply and demand for electrical energy in the control target area and the latest usage reservation status of the charging facility; and
subsequently, upon ending the trading period of the hour-ahead market for each frame on the target date, performing second processing in which a usage fee for an available time slot in the reservation table is changed or an acceptance of a reservation is prohibited based on the latest usage reservation status of the charging facility.

A method according to an embodiment of the present disclosure is a method performed by a terminal apparatus capable of communicating with a reservation apparatus for a charging facility installed in a control target area of electrical energy, the method includes:
receiving information on a reservation table for the charging facility from the reservation apparatus;
transmitting, to the reservation apparatus, a first request for a new usage reservation for a time slot on a target date selected from the reservation table;
upon an acceptance of the first request by the reservation apparatus, determining an operation plan for a vehicle to be used for delivery of a package on the target date, and notifying a recipient of a scheduled delivery time of the package;
when the reservation apparatus changes a usage fee for an available time slot in the reservation table, querying the recipient whether to allow a change in the scheduled delivery time;
when the recipient allows the change in the scheduled delivery time, transmitting a second request for a change of the reserved time slot to the available time slot whose usage fee has been changed; and
when the reservation apparatus accepts the second request, modifying the operation plan for the vehicle and notifying the recipient of a changed scheduled delivery time.

A system according to an embodiment of the present disclosure is a system including a reservation apparatus for a charging facility installed in a control target area of electrical energy, and a terminal apparatus capable of communicating with the reservation apparatus.

Upon starting a trading period of a spot market for a target date of electrical energy trading, the reservation apparatus starts accepting a new usage reservation or a changed reservation for each time slot on the target date in a reservation table for the charging facility.

The terminal apparatus is configured to:
receive information on the reservation table from the reservation apparatus;
transmit, to the reservation apparatus, a first request for a new usage reservation for a time slot on the target date selected from the reservation table;
upon an acceptance of the first request by the reservation apparatus, determine an operation plan for a vehicle to be used for delivery of a package on the target date, and notify a recipient of a scheduled delivery time of the package.

Upon starting a trading period of an hour-ahead market for the target date, the reservation apparatus performs first processing in which a usage fee for an available time slot in the reservation table is changed based on the latest prediction on supply and demand for electrical energy in the control target area and the latest usage reservation status of the charging facility.

When the reservation apparatus changes the usage fee for the available time slot in the reservation table, the terminal apparatus queries the recipient whether to allow a change in the scheduled delivery time.

When the recipient allows the change in the scheduled delivery time, the terminal apparatus transmits, to the reservation apparatus, a second request for a change of the reserved time slot to the available time slot whose usage fee has been changed.

When the reservation apparatus accepts the second request, the terminal apparatus modifies the operation plan for the vehicle and notifies the recipient of a changed scheduled delivery time.

Upon ending the trading period of the hour-ahead market for each frame on the target date, the reservation apparatus performs second processing in which a usage fee for an available time slot in the reservation table is changed or an acceptance of a reservation is prohibited based on the latest usage reservation status of the charging facility.

According to an embodiment of the present disclosure, technology for controlling electrical energy with taking into account supply and demand in the future is improved.

### BRIEF DESCRIPTION OF THE DRAWINGS

In the accompanying drawings:

FIG. 1 is a block diagram illustrating a schematic configuration of a system according to an embodiment of the present disclosure;

FIG. 2 is a diagram illustrating a first example of a usage reservation status of a charging facility;

FIG. 3 is a diagram illustrating a second example of the usage reservation status of the charging facility;

FIG. 4 is a diagram illustrating a third example of the usage reservation status of the charging facility;

FIG. 5 is a block diagram illustrating a schematic configuration of a reservation apparatus; and

FIG. 6 is a block diagram illustrating a schematic configuration of a terminal apparatus;

FIG. 7 is a flowchart illustrating operations of the reservation apparatus; and

FIG. 8 is a flowchart illustrating operations of the terminal apparatus.

### DETAILED DESCRIPTION

Hereinafter, an embodiment of the present disclosure will be described.

### Outline of Embodiment

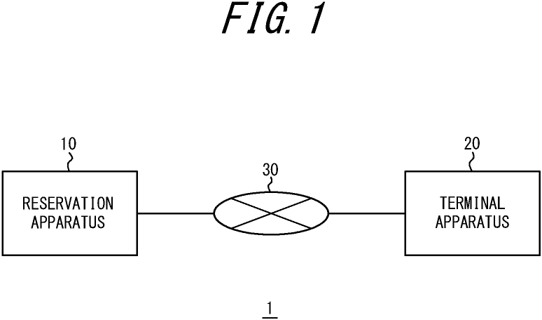

An outline of a system 1 according to an embodiment of the present disclosure will be described with reference to FIG. 1. The system 1 includes a reservation apparatus 10 and a terminal apparatus 20. The reservation apparatus 10 and the terminal apparatus 20 are communicably connected to a network 30 including, for example, the Internet.

The reservation apparatus 10 is, for example, any computer such as a server apparatus. The reservation apparatus 10 manages usage reservations for a charging facility installed in a control target area of electrical energy. The control target area is, for example, an area to be managed by a Community Energy Management System (CEMS), but is not limited to this. In the present embodiment, the charging facility includes one or more chargers that can charge vehicles such as Battery Electric Vehicles (BEVs). For example, the reservation apparatus 10 can accept a new usage reservation or a changed reservation for each charger for each predetermined time slot (for example, for each one-hour time slot). In the following explanation, accepting a new usage reservation for a certain time slot and accepting a designation of a certain time slot, as a change of a reserved time slot, are both referred to as “acceptances of reservations” without any particular distinction.

The terminal apparatus 20 is any computer used by a user, such as a Personal Computer (PC), smartphone, or tablet terminal, for example. A user who desires to use the charging facility described above can transmit, using the terminal apparatus 20, a request for a usage reservation for the charging facility, such as a new usage reservation or changed reservation for the charging facility, for example, to the reservation apparatus 10. The transmission of such a request may be performed, for example, via a native application program installed in the terminal apparatus 20, or via a general-purpose web browser application program.

In the present embodiment, an electric utility, such as an aggregation coordinator or resource aggregator, can determine a demand plan and a procurement plan based on a prediction on supply and demand for electrical energy in the control target area, purchase electrical energy the procurement of which from electrical energy trading markets is likely to be required based on the plan, and supply the electrical energy to the control target area. The electrical energy trading markets include, for example, a spot market (day-ahead market), an hour-ahead market (real time market), and the like.

The spot market is a market in which an electrical energy trading contract is made prior to a day before a target date of electrical energy trading (a future date on which purchased electrical energy is actually supplied). In the present embodiment, in the spot market, for example, 24 hours from 0:00 to 24:00 on the target date are divided into 48 frames of 30 minutes, and trading is conducted frame by frame. A trading period of the spot market starts 10 days before the target date and ends at 12:00 on the day before the target date. However, a concrete aspect of the spot market is not limited to this example.

The hour-ahead market is a market that starts after the end of the spot market. In the present embodiment, in the hour-ahead market, as in the spot market described above, 24 hours from 0:00 to 24:00 on the target date are divided into 48 frames of 30 minutes, and trading is conducted frame by frame. A trading period of the hour-ahead market, for each frame on the target date, starts at 17:00 on the day before the target date and ends one hour before the start of each frame. Thus, since trading is possible in the hour-ahead market up to just before the frame on the target date, even in a case in which balance between supply and demand for electrical energy is disrupted due to a sudden climate change, electrical energy generation problem, or the like on the day of the target date, the balance between supply and demand can be adjusted using the hour-ahead market. However, a concrete aspect of the hour-ahead market is not limited to this example.

In general, in a case in which there is a difference between planed demand and actual demand (i.e., in a case in which the same time and same amount as a planned value cannot be achieved), the electric utility needs to pay an imbalance charge. Therefore, it is desirable for the electric utility to reduce fluctuations in demand for electrical energy during a time period corresponding to a frame, after the trading period for the frame has ended in the hour-ahead market, in order to avoid paying the imbalance charge.

An outline of operations of the reservation apparatus 10 according to the present embodiment will be described, and details thereof will be described later. Upon starting a trading period of the spot market for a target date of electrical energy trading, the reservation apparatus 10 starts accepting a new usage reservation or a changed reservation for each time slot on the target date in the reservation table for the charging facility. Subsequently, upon starting a trading period of the hour-ahead market for the target date, the reservation apparatus 10 performs first processing in which a usage fee for an available time slot in the reservation table is changed based on the latest prediction on supply and demand for electrical energy in the control target area and the latest reservation status of the charging facility. When the trading period of the hour-ahead market ends for each frame on the target date, the reservation apparatus 10 performs second processing in which a usage fee for an available time slot in the reservation table is changed or an acceptance of a reservation is prohibited based on the latest usage reservation status of the charging facility.

Thus, according to the present embodiment, when the trading period of the hour-ahead market starts, the usage fee for the available time slot in the reservation table is changed by performing the first processing. For example, the usage fee for an available time slot that is included in a time period (hereinafter also referred to as “tight time period”) during which supply and demand for electrical energy are predicted to be tight on the target date may be increased. In such a case, technology for controlling electrical energy with taking into account supply and demand in the future is improved in that the probability that a new usage reservation for the available time slot or a designation of the available time slot, as a change of a reserved time slot, is made in preference to the other time slots is reduced, and therefore increase in demand for electrical energy during the tight time period can be prevented. For example, the usage fee for an available time slot that is not included in the tight time period may be reduced. In such a case, technology for controlling electrical energy with taking into account supply and demand in the future is improved in that the probability that a new reservation for the available time slot or a designation of the available time slot, as a change of a reserved time slot, is made in preference to the other time slots is increased, and therefore increase in demand for electrical energy during the tight time period can be prevented. In addition, it is possible to promote the use of the charging facility during time periods in which supply and demand for electrical energy are not tight.

Furthermore, according to the present embodiment, when the trading period of the hour-ahead market ends, the usage fee for the available time slot in the reservation table is changed or the acceptance of the reservation for the available time slot is prohibited by performing the second processing. For example, the usage fee for an available time slot corresponding to a frame whose trading period of the hour-ahead market has ended may be increased, or the acceptance of the reservation for such an available time slot may be prohibited. In such a case, technology for controlling electrical energy with taking into account supply and demand in the future is improved in that the probability that a new usage reservation for the time slot corresponding to the frame whose trading period of the hour-ahead market has ended or a designation of the time slot, as a change of a reserved time slot, is made is reduced, and therefore fluctuations in demand for electrical energy during the time period corresponding to the frame can be reduced. For example, the usage fee for an available time slot corresponding to a time period in which demand is likely to be low, relative to the demand plan, may be reduced. In such a case, technology for controlling electrical energy with taking into account supply and demand in the future is improved in that the probability that a new usage reservation for the available time slot or a designation of the available time slot, as a change of a reserved time slot, is made in preference to another available time slot (for example, an available time slot corresponding to a frame whose trading period of the hour-ahead market has ended) is increased, and therefore fluctuations in demand for electrical energy during the time period corresponding to the frame can be reduced.

When the trading period of the hour-ahead market has ended for each frame on the target date, the reservation apparatus 10 may further perform third processing in which the usage fee for a time slot corresponding to a frame whose trading period has ended is reduced in a case in which the time slot remains reserved before or after the end of the trading period. According to such a configuration, the reservation for the time slot whose usage fee has been reduced is less likely to be cancelled at the last minute, thus increasing the possibility of achieving the same time and same amount as a planned value.

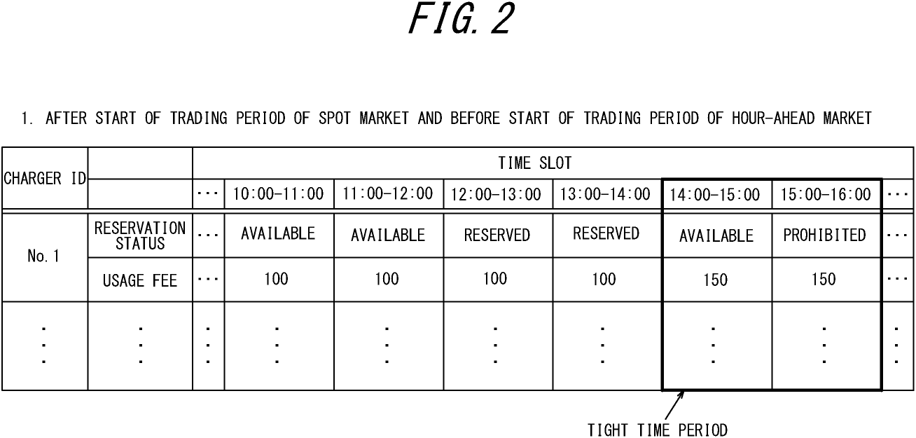

A specific example in which the reservation table for the charging facility is updated by the first, second, and third processing described above will be described with reference to FIGS. 2 to 4. FIGS. 2 to 4 illustrate a reservation table indicating usage reservation status of the charging facility at different times. In the present embodiment, the reservation table includes charger IDs and a plurality of time slots. The charger IDs are information that uniquely identifies each charger that the charging facility has. Each time slot is a unit of time for which a usage reservation for a corresponding charger can be accepted. In the present embodiment, a usage reservation for a charger can be accepted for each of the time slots into which 24 hours are divided by 24. However, each time slot in the reservation table is not limited to this example and may be freely determined. In the reservation table, a “reservation status” and a “usage fee” for each time slot are determined for one charger corresponding to the charger ID “No. 1”. The “reservation status” indicates any one of three types of status: “available”, “reserved”, and “prohibited”. “Available” indicates that the corresponding time slot is not reserved and is available for an acceptance of a reservation. “Reserved” indicates that the corresponding time slot has already been reserved and another reservation cannot be accepted. “Prohibited” indicates that an acceptance of a reservation is prohibited by the reservation apparatus 10.

FIG. 2 illustrates the reservation table indicating the usage reservation status on a target date at a time T1, after the start of a trading period of the spot market and before the start of a trading period of the hour-ahead market. At the time T1, the first processing described above is not performed, because the time T1 is before the start of the trading period of the hour-ahead market. Specifically, the two time slots “10:00-11:00” and “11:00-12:00” on the target date both have a reservation status of “available” and a usage fee of “100”. The two time slots “12:00-13:00” and “13:00-14:00” both have a reservation status of “reserved” and a usage fee of “100”. For simplicity of explanation, the two time slots are reserved by a user of the terminal apparatus 20. The time slot “14:00-15:00” has a reservation status of “available” and a usage fee of “150”. The time slot “15:00-16:00” has a reservation status of “prohibited” and a usage fee of “150”. In the latest prediction on supply and demand for electrical energy at the time T1, 14:00-16:00 is estimated as a tight time period, and the usage fee for the two time slots “14:00-15:00” and “15:00-16:00”, which are included in the tight time period, is set higher than that for the other time slots.

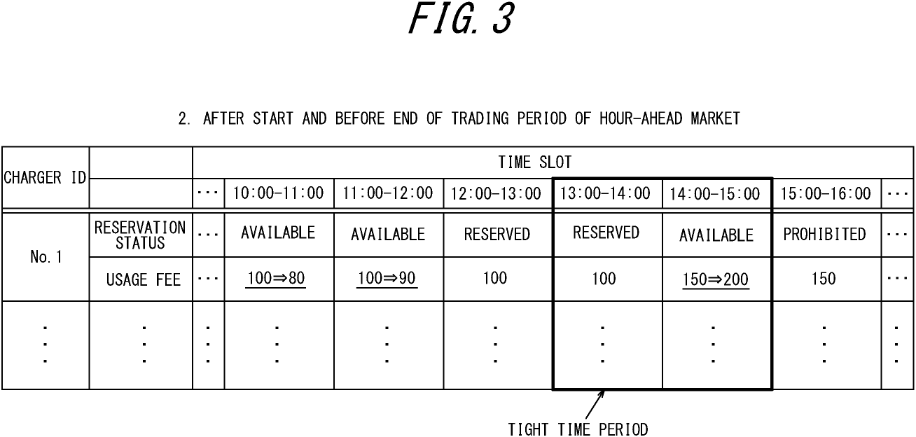

FIG. 3 illustrates the reservation table indicating the usage reservation status on the target date at a time T2, after the start and before the end of the trading period of the hour-ahead market. Here, the tight time period has changed to 13:00-15:00, based on the latest prediction on supply and demand for electrical energy. In addition, by performing the first processing described above, the usage fee for some of the available time slots is changed from that at the time T1. Specifically, the usage fee for the two available time slots of “10:00-11:00” and “11:00-12:00”, which are not included in the tight time period, is reduced from “100” to “80” and “90”, respectively. On the other hand, the usage fee for the available time slot of “14:00-15:00”, which is included in the tight time period, is increased from “150” to “200”.

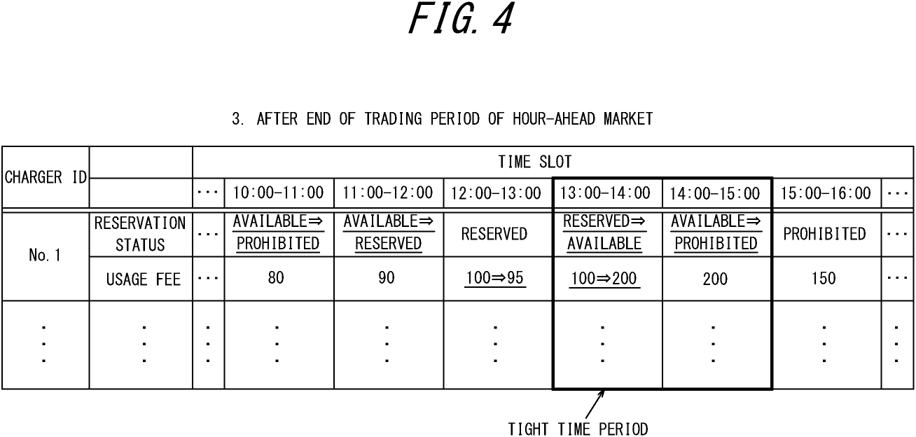

FIG. 4 illustrates the reservation table indicating the usage reservation status on the target date at a time T3, after the end of the trading period of the hour-ahead market. As described above, the trading period of the hour-ahead market ends one hour before each frame on the target date. Here, the time T3 is 13:00, and for the frame of 14:00-14:30 and earlier frames, the trading period of the hour-ahead market has ended. The reservation status and usage fee for some of the time slots are changed from those at the time T2. Specifically, by performing the second processing, the reservation status for the time slot “10:00-11:00” is changed from “available” to “prohibited”. The reservation status for the time slot “11:00-12:00” is changed from “available” to “reserved”. By performing the third processing, the usage fee for the time slot “12:00-13:00” is reduced from “100” to “95”. For the time slot “13:00-14:00”, since the reservation status is changed from “reserved” to “available”, the usage fee is increased from “100” to “200” by performing the second processing. In addition, the reservation status of the time slot “14:00-15:00” is changed from “available” to “prohibited” by performing the second processing.

Next, configurations of the system 1 will be described in detail.

### Configuration of Reservation Apparatus

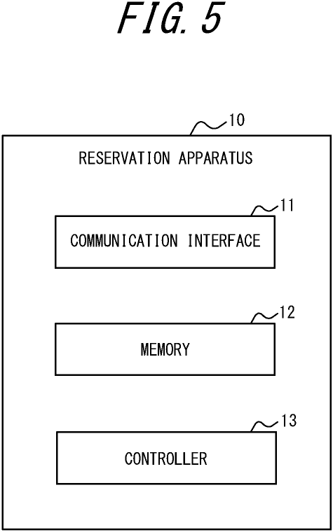

As illustrated in FIG. 5, the reservation apparatus 10 includes a communication interface 11, a memory 12, and a controller 13.

The communication interface 11 includes at least one interface for communication for connecting to the network 30. The interface for communication is compliant with mobile communication standards such as the 4th generation (4G) standard and the 5th generation (5G) standard, a wired local area network (LAN) standard, or a wireless LAN standard, for example, but not limited to these, and may be compliant with any communication standard. In the present embodiment, the reservation apparatus 10 communicates with the terminal apparatus 20 via the communication interface 11 and the network 30.

The memory 12 includes one or more memories. The memories are semiconductor memories, magnetic memories, optical memories, or the like, for example, but are not limited to these. The memories included in the memory 12 may each function as, for example, a main memory, an auxiliary memory, or a cache memory. The memory 12 stores any information to be used for operations of the reservation apparatus 10. For example, the memory 12 may store a system program, an application program, embedded software, and the like.

The controller 13 includes at least one processor, at least one programmable circuit, at least one dedicated circuit, or a combination of these. The processor is a general purpose processor such as a central processing unit (CPU) or a graphics processing unit (GPU), or a dedicated processor that is dedicated to specific processing, for example, but is not limited to these. The programmable circuit is a field-programmable gate array (FPGA), for example, but is not limited to this. The dedicated circuit is an application specific integrated circuit (ASIC), for example, but is not limited to this. The controller 13 controls operations of the entire reservation apparatus 10.

### Configuration of Terminal Apparatus

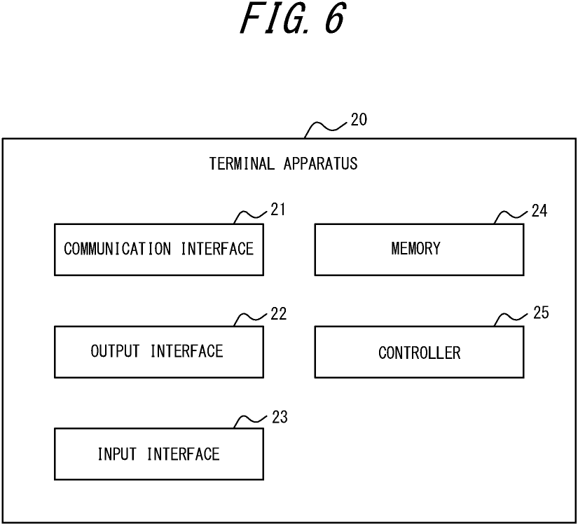

As illustrated in FIG. 6, the terminal apparatus 20 includes a communication interface 21, an output interface 22, an input interface 23, a memory 24, and a controller 25.

The communication interface 21 includes at least one interface for communication for connecting to the network 30. The interface for communication is compliant with, for example, a mobile communication standard, a wired LAN standard, or a wireless LAN standard, but not limited to these, and may be compliant with any communication standard. In the present embodiment, the terminal apparatus 20 communicates with the reservation apparatus 10 via the communication interface 21 and the network 30.

The output interface 22 includes at least one output device for outputting information to notify the user of the information. The output device is a display for outputting information as video, a speaker for outputting information as audio, or the like, for example, but is not limited to these. Alternatively, the output interface 22 may include an interface for connecting to an external output device.

The input interface 23 includes at least one input device for detecting user input. The input device is a physical key, a capacitive key, a mouse, a touch panel, a touch screen integrally provided with a display of the output interface 22, a microphone, or the like, for example, but is not limited to these. Alternatively, the input interface 23 may include an interface for connecting to an external input device.

The memory 24 includes one or more memories. The memories included in the memory 24 may each function as, for example, a main memory, an auxiliary memory, or a cache memory. The memory 24 stores any information to be used for operations of the terminal apparatus 20. For example, the memory 24 may store a system program, an application program, and the like.

The controller 25 includes at least one processor, at least one programmable circuit, at least one dedicated circuit, or a combination of these. The controller 25 controls operations of the entire terminal apparatus 20.

The present embodiment describes an example in which a logistics provider that delivers packages using a delivery vehicle is a user of the terminal apparatus 20. As described below, the terminal apparatus 20 can make a usage reservation for the charging facility in the control target area and can determine an operation plan of the delivery vehicle with taking into account a reservation time for the charging facility.

### Flow of Operations of Reservation Apparatus

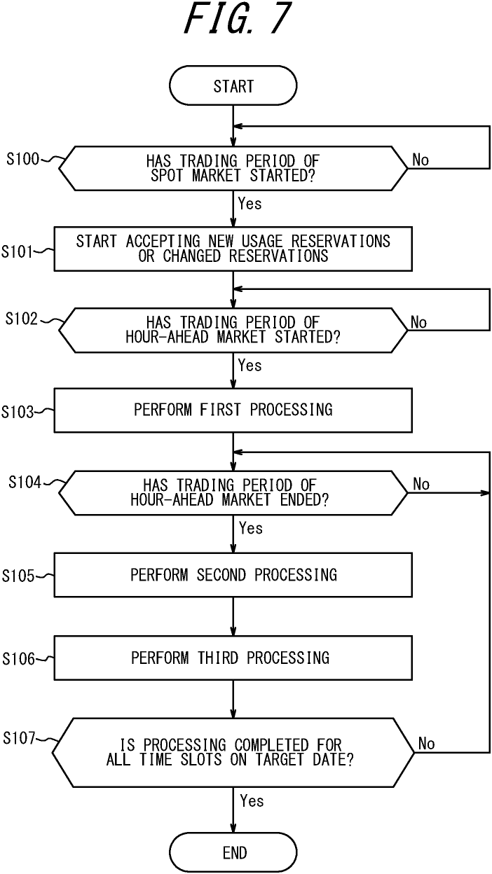

Operations of the reservation apparatus 10 according to the present embodiment will be described with reference to FIG. 7. The operations are performed for each target date of electrical energy trading.

Step S100: The controller 13 of the reservation apparatus 10 determines whether a trading period of the spot market for a target date of electrical energy trading has started. When it is determined that the trading period has started (step S100: Yes), the process advances to step S101. Conversely, when it is determined that the trading period has not started (Step S100: No), step S100 is repeated.

As described above, the trading period of the spot market starts, for example, 10 days before the target date. In such a case, the controller 13 determines 10 days before the target date that the trading period of the spot market has started.

Step S101: When it is determined in step S100 that the trading period of the spot market has started (Step S100: Yes), the controller 13 starts accepting a new usage reservation or a changed reservation for each time slot on the target date in a reservation table for the charging facility.

For example, upon receiving, from the terminal apparatus 20, a request for a reservation (a new usage reservation or a designation as a change of a reserved time slot) for a charger and a time slot selected by a user of the terminal apparatus 20, the controller 13 accepts the reservation when a reservation status of the charger at the time slot is “available”, and updates the reservation status from “available” to “reserved”. Note that, a usage fee for time slots that are included in a tight time period (14:00-16:00 in the example illustrated in FIG. 2) may be set higher than that for time slots that are not included in the tight time period. The tight time period may be determined by the CEMS based on the latest prediction on supply and demand for electrical energy, or by the controller 13, which acquires the latest prediction on supply and demand for electrical energy from the CEMS via the network 30.

Step S102: The controller 13 determines whether a trading period of the hour-ahead market for the target date has started. When it is determined that the trading period has started (step S102: Yes), the process advances to step S103. Conversely, when it is determined that the trading period has not started (Step S102: No), step S102 is repeated.

Step S103: When it is determined in step S102 that the trading period of the hour-ahead market has started (step S102: Yes), the controller 13 performs the first processing in which a usage fee for an available time slot in the reservation table is changed based on the latest prediction on supply and demand for electrical energy in the control target area and the latest usage reservation status of the charging facility.

Specifically, the controller 13 acquires information on a tight time period determined based on the latest prediction on supply and demand for electrical energy. For example, in FIG. 3, the tight time period is updated to 13:00-15:00. In a case in which the available time slot in the reservation table is included in the tight time period, the controller 13 may increase the usage fee for the available time slot. For example, in FIG. 3, the usage fee for the available time slot “14:00-15:00”, which is included in the tight time period, is increased. In a case in which the available time slot in the reservation table is not included in the tight time period, the controller 13 may reduce the usage fee for the available time slot. For example, in FIG. 3, the usage fee for the two available time slots “10:00-11:00” and “11:00-12:00” is reduced. The amount of change in the usage fee by the first processing is determined so that, for example, the greater the difference between supply and demand, the greater the change in the usage fee, but is not limited to this and may be determined arbitrarily.

Step S104: The controller 13 determines whether the trading period of the hour-ahead market has ended for each frame on the target date. When it is determined that the trading period has ended for a certain frame on the target date (step S104: Yes), the process proceeds to step S105. Conversely, when it is determined that the trading period has not ended for any of the frames (Step S104: No), step S104 is repeated.

As described above, the trading period of the hour-ahead market for each frame on the target date ends, for example, one hour before the start of each frame. In such a case, the controller 13 determines, one hour before the start of the certain frame, that the trading period of the hour-ahead market for the frame has ended.

Step S105: When it is determined in step S104 that the trading period of the hour-ahead market has ended for a certain frame on the target date (step S104: Yes), the controller 13 performs the second processing in which a usage fee for an available time slot in the reservation table is changed or an acceptance of a reservation is prohibited based on the latest prediction on supply and demand for electrical energy in the control target area and the latest usage reservation status of the charging facility.

Specifically, the controller 13 acquires information on a tight time period determined based on the latest prediction on supply and demand for electrical energy. Here, as illustrated in FIG. 4, the tight time period is assumed to remain unchanged at 13:00-15:00. It is also assumed that in the latest usage reservation status, one reservation is changed from the time slot of “13:00-14:00” to the time slot of “11:00-12:00”. The controller 13 may increase a usage fee for an available time slot corresponding to a frame whose trading period of the hour-ahead market has ended, or may prohibit an acceptance of a reservation (an acceptance of a new usage reservation or a designation as a change of a reserved time slot). For example, in the example illustrated in FIG. 4, when the trading period for a frame of 10:00-10:30 ends at 9:00 on the target date, the controller 13 prohibits an acceptance of a reservation for an available time slot “10:00-11:00” corresponding to the frame. When the trading period for a frame of 13:00-13:30 ends at 12:00 on the target date, the controller 13 increases a usage fee for an available time slot “13:00-14:00” corresponding to the frame from “100” to “200”. When the trading period for a frame of 14:00-14:30 ends at 13:00 on the target date, the controller 13 prohibits an acceptance of a reservation for an available time slot “14:00-15:00” corresponding to the frame.

Step S106: The controller 13 performs the third processing in which a usage fee for a time slot corresponding to the frame whose trading period of the hour-ahead market has ended is reduced when the time slot remains reserved before or after the end of the trading period.

For example, in the example illustrated in FIG. 4, when the trading period for a frame of 12:00-12:30 ends at 11:00 on the target date, the controller 13 reduces a usage fee for a time slot of “12:00-13:00” corresponding to the frame from “100” to “95”, because the time slot remains “reserved” before and after the end of the trading period.

Step S107: The controller 13 determines whether processing of steps S104 to S106 described above is completed for all the time slots in the reservation table on the target date. When it is determined that the processing is completed (step S107: Yes), the process ends. Conversely, when it is determined that the processing is not completed (S107: No), the process returns to step S104.

As described above, when the trading period of the spot market on the target date of electrical energy trading has started, the reservation apparatus 10 according to the present embodiment starts accepting the new use reservation or the changed reservation for each time slot on the target date in the reservation table for the charging facility. Subsequently, upon starting the trading period of the hour-ahead market on the target date, the reservation apparatus 10 performs the first processing in which the usage fee for the available time slot in the reservation table is changed based on the latest prediction on supply and demand for electrical energy in the control target area and the latest reservation status of the charging facility. When the trading period of the hour-ahead market ends for each frame on the target date, the reservation apparatus 10 performs the second processing in which the usage fee for the available time slot in the reservation table is changed or the acceptance of the reservation is prohibited based on the latest usage reservation status of the charging facility.

According to the operations of the reservation apparatus 10 described above, technology for controlling electrical energy with taking into account supply and demand in the future is improved in that the probability that, for example, a new usage reservation for an available time slot included in a tight time period or a designation of the available time slot, as a change of a reserved time slot, is made in preference to the other time slots is reduced, and therefore increase in demand for electrical energy during the tight time period can be prevented.

### Flow of Operations of Terminal Apparatus

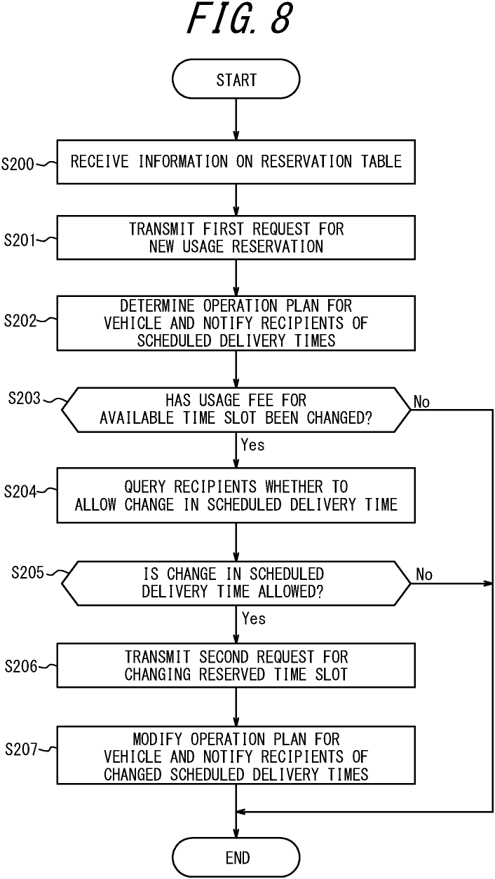

Operations of the terminal apparatus 20 according to the present embodiment will be described with reference to FIG. 8. As described above, in the present embodiment, a user of the terminal apparatus 20 is a logistics provider who delivers packages using a delivery vehicle. The operations of the terminal apparatus 20 include, in outline, operations of making a new usage reservation and a changed reservation for the charging facility, and modifying an operation plan for the delivery vehicle in accordance with the changed reservation for the charging facility.

Step S200: The controller 25 of the terminal apparatus 20 receives information on a reservation table for the charging facility from the reservation apparatus 10.

Specifically, the controller 25 receives the information on the reservation table for the charging facility from the reservation apparatus 10 via the communication interface 21. The information on the reservation table includes, for example, a reservation status and a usage fee for each charger that the charging facility has, as illustrated in FIG. 2.

Step S201: The controller 25 transmits, to the reservation apparatus 10, a first request for a new usage reservation for a charger and a time slot on a target date, which are selected by the user (here, the logistics provider) from the reservation table.

Step S202: When the reservation apparatus 10 accepts the new usage reservation in the first request, the controller 25 determines an operation plan for the delivery vehicle on the target date and notifies recipients of scheduled delivery times of the packages.

Specifically, when the controller 25 receives a notification from the reservation apparatus 10 that the new usage reservation in the first request has been accepted, the controller 25 determines the operation plan for the delivery vehicle on the target date. The operation plan is information including, for example, positions, traveling routes, and the like of the delivery vehicle with time. In step S202, the operation plan for the delivery vehicle is determined so that the delivery vehicle is charged by the charger in a time period of the reserved time slot, while delivering the packages to be delivered on the target date to the recipients. For example, the controller 25 can determine the operation plan by any routing algorithm, based on position information on delivery destinations of the packages to be delivered on the target date, position information on the reserved charger, and the time period corresponding to the reserved time slot.

Step S203: The controller 25 determines whether the reservation apparatus 10 has changed the usage fee for any available time slot in the reservation table. When it is determined that the usage fee for an available time slot has been changed (step S203: Yes), the process advances to step S204. Conversely, when it is determined that the usage fee for any available time slot has not been changed (step S203: No), the process ends.

Specifically, upon receiving information indicating a changed usage fee for an available time slot from the reservation apparatus 10 via the communication interface 21, the controller 25 determines that the usage fee for the available time slot has been changed by the reservation apparatus 10.

Step S204: When it is determined in step S203 that the usage fee for the available time slot has been changed (step S203: Yes), the controller 25 queries each of the recipients whether to allow a change in the scheduled delivery time.

Specifically, assuming that the reserved time slot is changed to the available time slot whose usage fee is determined to be changed in step S203, the controller 25 determines a modification of the operation plan that simultaneously satisfies both a first condition that the usage fee to be paid by the user, the logistics provider, is lower than before the change of the reserved time slot, and a second condition that the packages that should be delivered on the target date can be delivered to the recipients. When the modification of the operation plan that simultaneously satisfies both the first and second conditions can be determined, the controller 25 transmits, to a computer of each of the recipients whose scheduled delivery time changes when the operation plan is modified, a message querying whether to allow a change in the scheduled delivery time.

Step S205: The controller 25 determines whether the recipients have allowed the change in the scheduled delivery time. When it is determined that the change in the scheduled delivery time has been allowed (step S205: Yes), the process advances to step S206. Conversely, when it is determined that the change in the scheduled delivery time has not been allowed (step S205: No), the process ends.

Specifically, upon receiving a response indicating allowance of the change in the scheduled delivery time from the computer of each of the recipients that have been queried in step S204 whether to allow the change in the scheduled delivery time, the controller 25 determines that the change in the scheduled delivery time is allowed.

Step S206: When it is determined in step S205 that the change in the scheduled delivery time is allowed (step S205: Yes), the controller 25 transmits, to the reservation apparatus 10, a second request for changing the reserved time slot to the available time slot in step S203.

Step S207: When the reservation apparatus 10 accepts the change of the reserved time slot in the second request, the controller 25 modifies the operation plan for the delivery vehicle according to the modification in step S204 and notifies the recipients of the modified scheduled delivery times. The process then ends.

As described above, the terminal apparatus 20 according to the present embodiment receives information on a reservation table for the charging facility from the reservation apparatus 10. The terminal apparatus 20 transmits, to the reservation apparatus 10, a first request for a new usage reservation for a time slot on a target date, which is selected from the reservation table. Upon an acceptance of the first request by the reservation apparatus 10, the terminal apparatus 20 determines an operation plan for a delivery vehicle on the target date and notifies recipients of scheduled delivery times of packages. Subsequently, when the reservation apparatus 10 changes a usage fee for an available time slot in the reservation table, the terminal apparatus 20 queries each of the recipients whether to allow a change in the scheduled delivery time. When the recipients allow the change in the scheduled delivery time, the terminal apparatus 20 transmits, to the reservation apparatus 10, a second request for changing the reserved time slot to the available time slot whose usage fee has been changed. When the second request is accepted by the reservation apparatus 10, the operation plan for the delivery vehicle is modified and the recipients are notified of the modified scheduled delivery times.

According to the terminal apparatus 20 of the present embodiment, when the new usage reservation for the charging facility on the target date is accepted, the operation plan for the delivery vehicle is automatically determined so that the delivery vehicle is charged in the reserved time slot, while delivering each of the packages that should be delivered on the target date to each recipient. Subsequently, when the reservation apparatus 10 changes the usage fee for the available time slot, the query about whether to allow the change in the scheduled delivery time is automatically transmitted to the recipients. When the recipients allow the change in the scheduled delivery time, the reservation is automatically changed to the available time slot whose usage fee has been changed, and the operation plan for the delivery vehicle is automatically modified according to the changed reservation. This enables the logistics provider to reduce the workload of changing the reservation for the charging facility, modifying the operation plan for the delivery vehicle, and querying the recipients whether to allow the change in the scheduled delivery time, according to the change in the usage fee for the charging facility.

While the present disclosure has been described with reference to the drawings and examples, it should be noted that various modifications and revisions may be implemented by those skilled in the art based on the present disclosure. Accordingly, such modifications and revisions are included within the scope of the present disclosure. For example, functions or the like included in each component, each step, or the like can be rearranged without logical inconsistency, and a plurality of components, steps, or the like can be combined into one or divided.

For example, an embodiment in which the configurations and operations of the reservation apparatus 10 and the terminal apparatus 20 in the above embodiment are distributed to multiple computers capable of communicating with each other can be implemented.

In the embodiment described above, the controller 25 of the terminal apparatus 20 may also provide an incentive to each of the recipients who has allowed the change in the scheduled delivery time in step S207 described above. As the incentive, for example, electronic data such as electronic money or virtual currency may be employed, or goods such as coupons or novelties may be employed.

For example, an embodiment in which a general purpose computer functions as the reservation apparatus 10 or the terminal apparatus 20 according to the above embodiment can also be implemented. Specifically, a program in which processes for realizing the functions of the reservation apparatus 10 or the terminal apparatus 20 according to the above embodiment are written may be stored in a memory of a general purpose computer, and the program may be read and executed by a processor. Accordingly, the present disclosure can also be implemented as a program executable by a processor, or a non-transitory computer readable medium storing the program.

1. A method performed by a reservation apparatus for a charging facility installed in a control target area of electrical energy, the method comprising:
upon starting a trading period of a spot market for a target date of electrical energy trading, starting accepting a new usage reservation or a changed reservation for each time slot on the target date in a reservation table for the charging facility;
subsequently, upon starting a trading period of an hour-ahead market for the target date, performing first processing in which a usage fee for an available time slot in the reservation table is changed based on a latest prediction on supply and demand for electrical energy in the control target area and a latest usage reservation status of the charging facility; and
subsequently, upon ending the trading period of the hour-ahead market for each frame on the target date, performing second processing in which a usage fee for an available time slot in the reservation table is changed or an acceptance of a reservation is prohibited based on the latest usage reservation status of the charging facility.

2. The method according to claim 1, wherein
the reservation apparatus is configured to:
in the first processing,
acquire information on a time period during which supply and demand for electrical energy are predicted to be tight, the time period being determined based on the latest prediction on supply and demand for electrical energy in the control target area;
increase the usage fee for the available time slot, in a case in which the available time slot in the reservation table is included in the time period; and
reduce the usage fee for the available time slot, in a case in which the available time slot in the reservation table is not included in the time period.

3. The method according to claim 1, wherein the reservation apparatus is configured to, in the second processing, increase the usage fee for the available time slot corresponding to a frame whose trading period of the hour-ahead market has ended, or prohibit the acceptance of the reservation for the available time slot corresponding to the frame whose trading period of the hour-ahead market has ended.

4. The method according to claim 1, further comprising, upon ending the trading period of the hour-ahead market for each frame on the target date, performing third processing in which a usage fee for a time slot corresponding to a frame whose trading period has ended is reduced in a case in which the time slot remains reserved before and after the end of the trading period.

5. A method performed by a terminal apparatus capable of communicating with a reservation apparatus for a charging facility installed in a control target area of electrical energy, the method comprising:
receiving information on a reservation table for the charging facility from the reservation apparatus;
transmitting, to the reservation apparatus, a first request for a new usage reservation for a time slot on a target date selected from the reservation table;
upon an acceptance of the first request by the reservation apparatus, determining an operation plan for a vehicle to be used for delivery of a package on the target date, and notifying a recipient of a scheduled delivery time of the package;
when the reservation apparatus changes a usage fee for an available time slot in the reservation table, querying the recipient whether to allow a change in the scheduled delivery time;
when the recipient allows the change in the scheduled delivery time, transmitting a second request for a change of the reserved time slot to the available time slot whose usage fee has been changed; and
when the reservation apparatus accepts the second request, modifying the operation plan for the vehicle and notifying the recipient of a changed scheduled delivery time.

6. The method according to claim 5, further comprising providing an incentive to the recipient when the recipient allows the change in the scheduled delivery time.

7. A system comprising a reservation apparatus for a charging facility installed in a control target area of electrical energy, and a terminal apparatus capable of communicating with the reservation apparatus, wherein
upon starting a trading period of a spot market for a target date of electrical energy trading, the reservation apparatus starts accepting a new usage reservation or a changed reservation for each time slot on the target date in a reservation table for the charging facility,
the terminal apparatus is configured to:
receive information on the reservation table from the reservation apparatus;
transmit, to the reservation apparatus, a first request for a new usage reservation for a time slot on the target date selected from the reservation table; and
upon an acceptance of the first request by the reservation apparatus, determine an operation plan for a vehicle to be used for delivery of a package on the target date, and notify a recipient of a scheduled delivery time of the package,
upon starting a trading period of an hour-ahead market for the target date, the reservation apparatus performs first processing in which a usage fee for an available time slot in the reservation table is changed based on a latest prediction on supply and demand for electrical energy in the control target area and a latest usage reservation status of the charging facility,
when the reservation apparatus changes the usage fee for the available time slot in the reservation table, the terminal apparatus queries the recipient whether to allow a change in the scheduled delivery time,
when the recipient allows the change in the scheduled delivery time, the terminal apparatus transmits, to the reservation apparatus, a second request for a change of the reserved time slot to the available time slot whose usage fee has been changed,
when the reservation apparatus accepts the second request, the terminal apparatus modifies the operation plan for the vehicle and notifies the recipient of a changed scheduled delivery time, and
upon ending the trading period of the hour-ahead market for each frame on the target date, the reservation apparatus performs second processing in which a usage fee for an available time slot in the reservation table is changed or an acceptance of a reservation is prohibited based on the latest usage reservation status of the charging facility.
